(19) United States
(12) Patent Application Publication
(10) Pub. No.: US 2005/0026666 A1
(43) Pub. Date: Feb. 3, 2005

(54) Make a great deal electronic video poker

(76) Inventors: John Tumacder, Reno, NV (US); Delmalyn U. Tumacder, Reno, NV (US)

Correspondence Address: John Tumacder, #267, 4790 Caughlin Pkwy, Reno, NV, 89509, US

(21) Appl. No.: 10/859,900

(22) Filed: Jun. 3, 2004

Related U.S. Application Data
(60) Provisional application No. 60/475,670, filed on Jun. 4, 2003.

(51) Int. Cl. A63F 13/00

(52) U.S. Cl. 463/13

(57) ABSTRACT

In a video draw poker game the player selects the five cards which will be the initial deal of cards from the field of the entire deck of cards dealt face down on the upper half of the video screen. The player also selects which cards are to be dealt for the draw for replacement cards.

### CROSS-REFERENCE TO RELATED APPLICATIONS

This Application claims the benefit of Applicants' provisional patent Application No. 60/475,670 entitled Make a great deal electronic video poker filed Jun. 4, 2003.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK, APPENDIX

Not Applicable

### BACKGROUND OF THE INVENTION

The field of endeavor to which this invention pertains is the gaming machine industry and more particularly, video poker machines. This invention relates primarily to any of the many variations of electronic video poker machines which are played in the various legal gaming establishments. In all of the many variations of one game at a time video draw poker the player, after registering credits on the video poker machine by the insertion of money or tokens, usually starts the game by selecting an amount to be wagered allowed by the particular machine and then by depressing a start button. (Most video poker machines will automatically commence play when the maximum wager allowed is played). Five cards are then automatically dealt face up on the video screen. The player then selects which cards he/she wishes to hold and unwanted cards are discarded and then automatically replaced. If after the draw of the replacement cards the player's poker hand qualifies as a winning hand according to the payout schedule of the particular game, then the appropriate amount of credits are added to the player's balance of credits.

The procedure for playing video poker is significantly changed in the procedure set forth in this non provisional patent application. Rather than having no control over the automatically dealt cards in the usual method of playing video poker, the player in the invention described herein chooses the original five cards he/she is dealt as well as the draw cards. This is accomplished by a design of the video screen wherein all fifty-two cards of a standard deck of playing cards are randomly dealt face down on the top half of the screen at the start of each game. By utilization of touch screen technology, the player then selects and touches which cards will be dealt on the original deal and also selects and touches which cards he/she wants on the draw for the discards.

### BRIEF SUMMARY OF THE INVENTION

The object of this invention is to enhance the enjoyment of playing video poker machines. Another object is to render baseless any allegation that the outcome of games in video poker machines is “fixed” in any way and thus prevent costly litigation on that issue. Another object is to promote responsible gaming by placing game appropriate responsible gaming messages on the machine during the course of play and by slowing down the pace of play. Applicants believe that all of these objectives can be achieved by the design of this invention which allows players to choose their cards when they play video poker.

Applicants believe that the enjoyment of gambling is enhanced for the players when they have a degree of control over the outcome of the game. Applicants believe that the popularity of craps derives from the sense of control a craps player has when he/she throws the dice at the craps table. The ‘shooter’ is elated when the desired number comes out and feels dejected when a losing number is rolled. This similar kind of personal pride in winning and personal anguish in losing can occur in “Make a great deal video poker.’ Applicants believe that a player who selects the cards to make a royal flush will feel a greater sense of accomplishment and elation than a player who is merely dealt a royal flush.

At the time of the filing of this non provisional patent application a federal lawsuit is pending against gaming machine manufacturers and casinos wherein plaintiffs allege that “the ‘cards dealt’ or ‘drawn’ in video poker do not, in fact, possess the characteristics of games of chance or operate as defendants have misled their patrons to believe.” Whether or not this allegation will later be proved at trial remains to be seen. The design of the invention herein prevents even the suspicion of such an allegation and erases any doubt as to the fairness of the game since the cards which come into play are selected by the players themselves and they have total control of what cards are dealt in every game.

This invention also contributes to the need for the gaming industry to deal with the issue of problem and pathological gambling. Although only a tiny fraction of video poker players may be problem gamblers, there is a need to promote the message of responsible gambling to those who may be inclined toward addiction. This invention can instill responsible gaming attitudes for the player by the placing of appropriate, amusing, and non offensive messages on the video screen during the course of the game. Examples of such messages for ‘Make a great deal video poker’ include “Choose to be a winner!, ‘“Dealing with it is your responsibility!,’ “A great deal is under your control!,” “Let's play with a full deck!”

Another way that this invention helps to deal with video poker addiction is by the slowing down of play. By letting the players take their time to select their cards, fast and frenzied play by rapid dealing machines is prevented.

### BRIEF DESCRIPTION OF THE SEVERAL VIEWS OF THE DRAWING

FIG. 1 shows the screen at the beginning of the game

FIG. 2 shows the screen after the player has selected five cards

FIG. 3 shows the screen after the five cards have turned over and the player has selected three replacement cards

FIG. 4 shows the screen after the replacement cards have turned over and the player is awarded credits accordingly

FIG. 5 shows the screen where all cards are turned over assuring the player that all cards were in play

FIG. 6 shows the screen at the start of a new game

### DETAILED DESCRIPTION OF THE INVENTION

In all existing video poker machines throughout gaming establishments players are given no choice in determining which cards are dealt. Rather, the machine automatically deals out the initial five cards as well as the replacement cards. This invention is distinguished from existing video poker machines by the inclusion of a feature allowing the player to select which cards are to be dealt. This is accomplished by utilizing the upper half of the video screen to display all the cards randomly dealt face down at the beginning of each game and allowing the player to choose which cards he/she wants to be dealt. This invention is also distinguished from existing video poker machines by the placement of responsible gaming messages on the video screen during the course of the game.

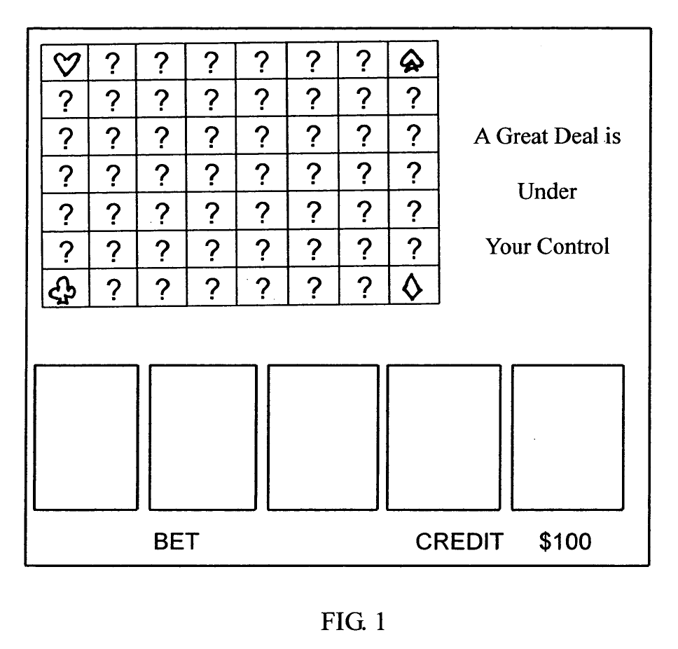

The best mode contemplated to carry out the invention is by designing the video screen as shown in FIG. 1. The upper half of the screen contains an eight by seven grid, a total of fifty-six spaces. The four corners contain one of the four suit symbols, ie heart, diamond, club, spade. Each of the remaining fifty-two spaces represents one of the cards in a standard deck of fifty-two cards which has been randomly dealt face down. A question mark is used as a design for the back of the cards in this example although a casino's logo may be easily applied. The bottom half of the screen contains the spaces where the five cards in the draw poker game will be displayed. In this example the player has a credit balance of $100. For purposes of this example the game is a dollar denominated game. The responsible gaming message on the screen reads “A Great Deal is Under Your Control.”

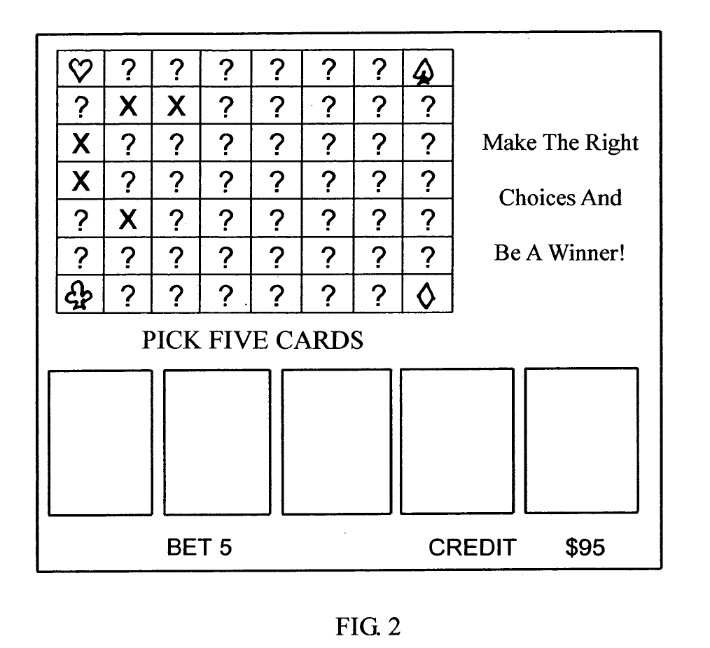

In FIG. 2 the player has wagered $5, the usual maximum bet in a dollar denominated game thereby leaving a credit balance of $95. The prompt “PICK FIVE CARDS” appears on the screen and the player has marked five cards on the video screen. With the use of standard touch screen technology the player's touching of a card spot on the screen resulted in the spot being marked with an “X.” The responsible gaming message on the screen reads “Make The Right Choices And Be A Winner!”

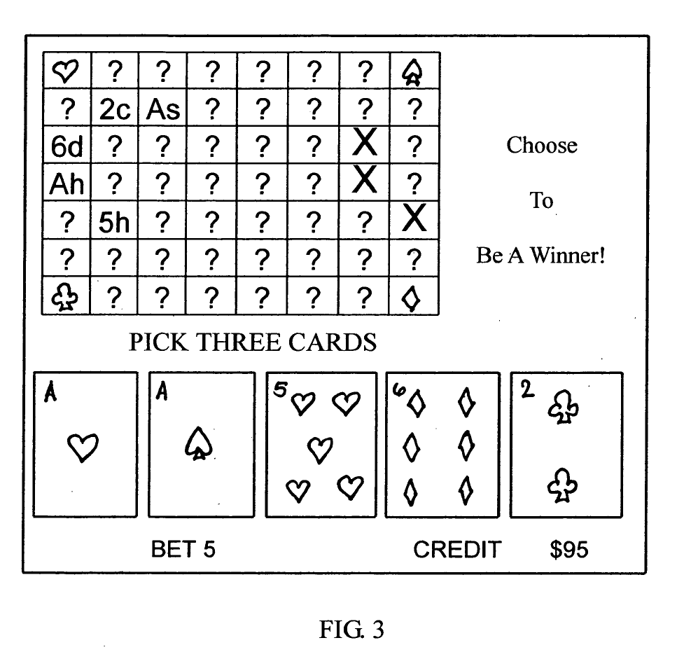

FIG. 3 depicts the screen after the player has pressed a start button signifying he/she has settled on which five cards are to be dealt on the initial deal. The five marked cards have turned over revealing that the Aces of hearts and spades, the five of hearts, six of diamonds, and two of clubs were selected and appear in the five card positions on the bottom of the screen. The player has decided to hold the two Aces. The prompt “PICK THREE CARDS” then appears. The player has selected which three cards are to be dealt and those three cards are now marked with an “X.” The responsible gaming message on the screen reads “Choose To Be A Winner!”

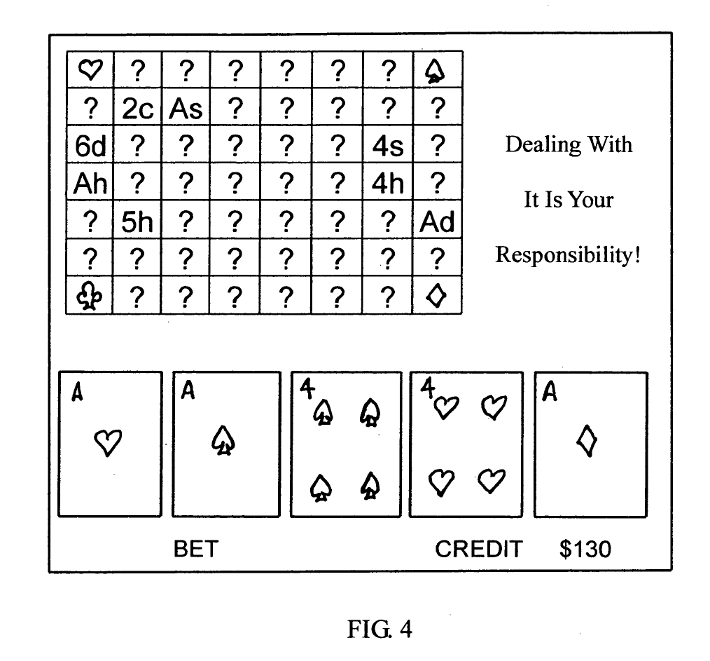

FIG. 4 shows the results after the player has pressed the draw button. The fours of spades and hearts and the Ace of diamonds were the draw cards selected. The poker hand results in a full house, three Aces and two fours, and in this particular game wins $35. The player's credit balance now shows $130 since $35 was added to the previous balance of $95. The responsible gaming message on the screen reads “Dealing With It Is Your Responsibility!”

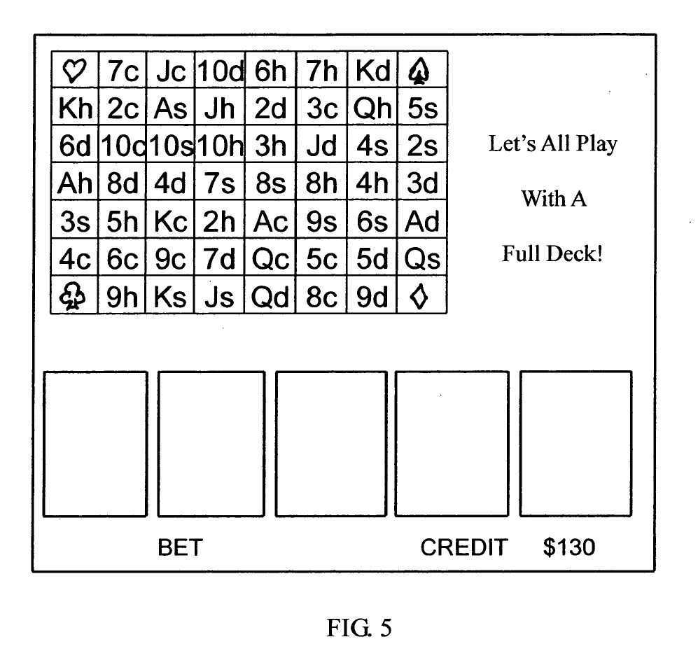

FIG. 5 shows the screen a few seconds after the conclusion of the game. All of the cards are turned over to give the player instant feedback on where all the cards were located for the particular game. The responsible gaming message on the screen reads “Let's All Play With A Full Deck!”

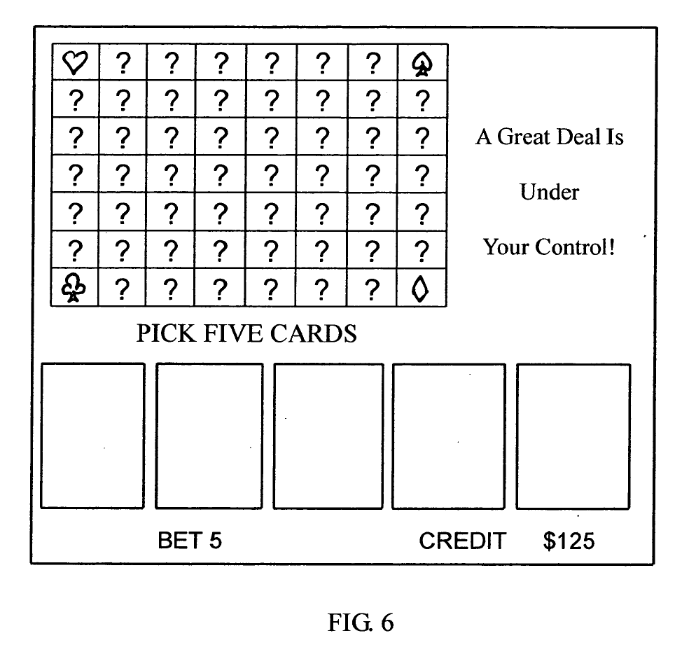

FIG. 6 shows the screen after the player has wagered $5 bringing the balance of credits down to $125 and the prompt to “PICK FIVE CARDS” appears again.

1. A method of playing video draw poker comprising:
a) allowing the player to determine which cards will be dealt on the initial deal of five cards
b) allowing the player to determine which cards will be dealt on the draw for replacement cards
c) designing the video screen so that the upper half of the screen displays all fifty-two cards randomly dealt face down at the beginning of each game making possible 1a) and 1b) above.

2. A method of playing video poker comprising the placing of messages promoting responsible gaming on the video screen during the course of the game.
